(19) United States
(12) Patent Application Publication
(10) Pub. No.: US 2005/0105959 A1
(43) Pub. Date: May 19, 2005

(54) GreetingsBook

(76) Inventor: Tony Ray Haynes, Valencia, CA (US)

Correspondence Address: Tony Haynes, #344, 24307 Magic Mountain Parkway, Valencia, CA, 91355, US

(21) Appl. No.: 10/769,724

(22) Filed: Feb. 2, 2004

Related U.S. Application Data
(60) Provisional application No. 60/520,552, filed on Nov. 17, 2003.

(51) Int. Cl. B42F 3/06

(52) U.S. Cl. 402/57

(57) ABSTRACT

The drawings point out and highlight the 90 to 110 lb-8½″ by 11″ paper's scoring, perforation and spiral binding, as well as the text on one side of the page at the bottom and art on the other side of the page at the top. The drawings show the pouch and envelopes as well. These elements when combined create a GreetingsBook.

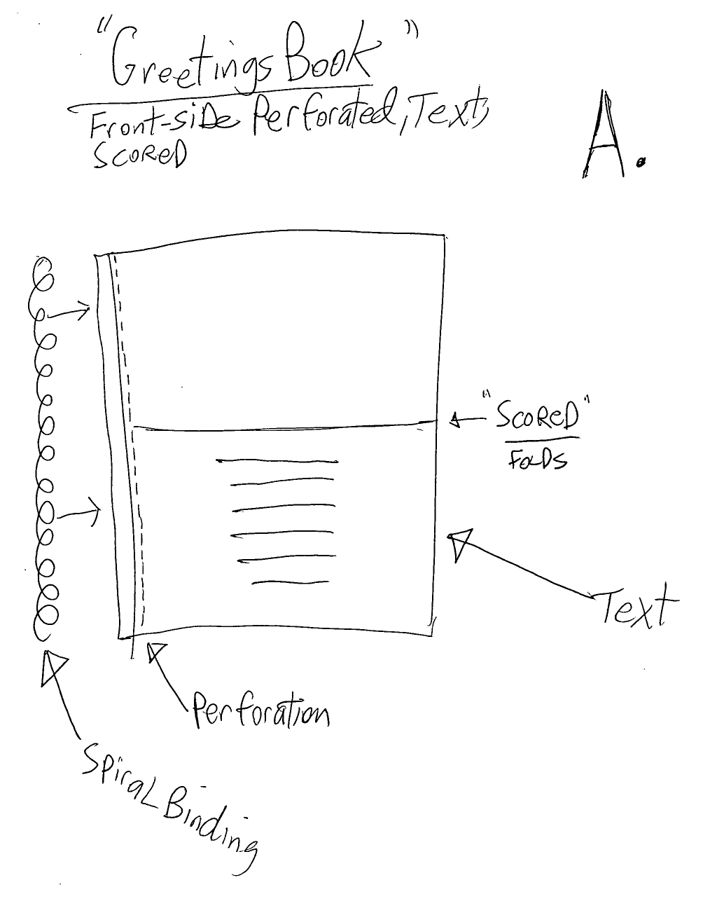

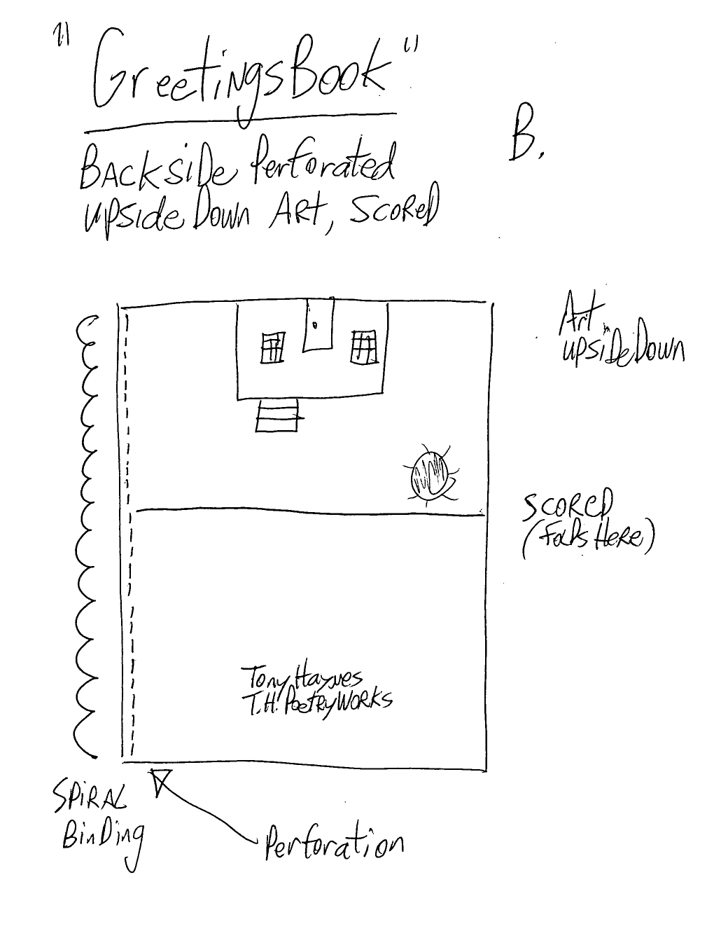

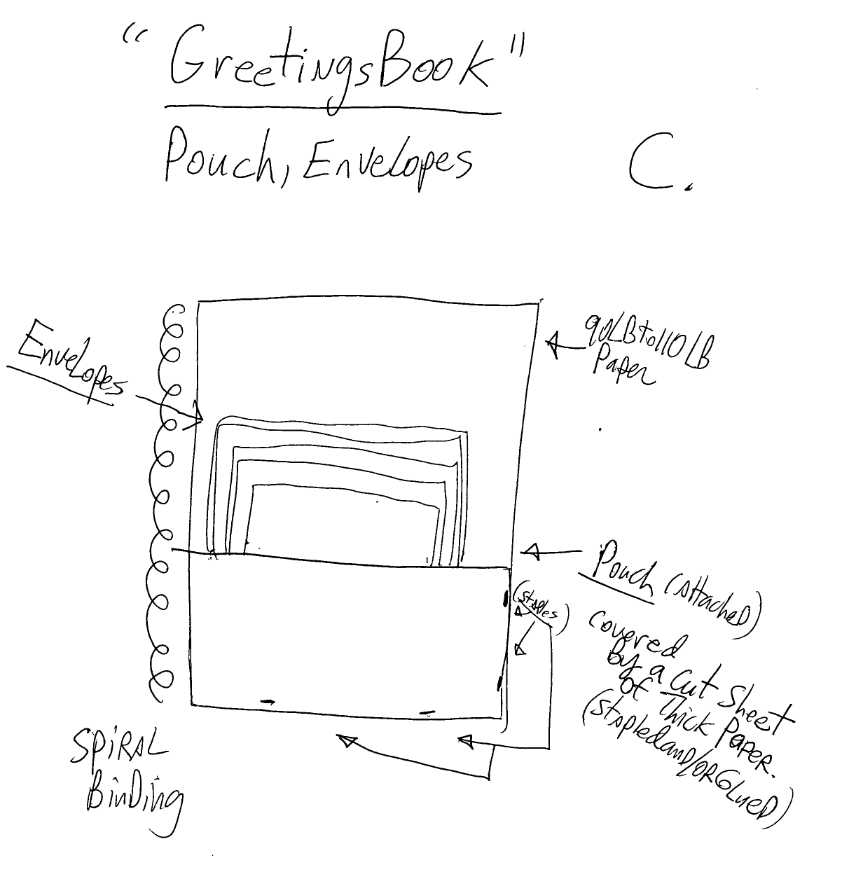

### SPECIFICATION & DETAILED DESCRIPTION

The elements of The GreetingsBook are as follows; 10-to-30 sheets of thick paper, 90 lb. or greater. 8½″ By 11″ or smaller. All pages, excluding the cover page, back cover page, pouch page and table of contents are perforated, so that these pages can be torn out neatly. These pages are also ‘scored’, so they can be folded in half and create a greeting card if the user decides to tear them out of the GreetingsBook. These 10 to 30 sheets of paper are then stacked together. An additional sheet of thick paper is now added and placed just ahead of the back cover page. This sheet has a pouch. Envelopes are placed in the pouch. The amount of envelopes ranges from 8 to 30, depending on the amount of perforated & scored pages within the GreetingsBook. After the additional sheet with pouch is added, all of the elements are spiral bound. Now we have a complete GreetingsBook. The perforated pages within the GreetingsBook have text at the bottom portion of the page below the scored section. The top of the page is blank. On the backside, the top of each page displays the artwork. Inside of the GreetingsBook, the artwork appears upside down. This way, when the perforated page is torn out and it is folded at the point where it is scored, it will be come a greeting card complete with art. The bottom portion of the backside of the page has company info, etc. . . .

### BACKGROUND OF THE INVENTION

This invention relates to the Greeting Card industry and the Spiral Bound Perforated Note Book industry. More particularly, this invention fulfills a need for the consumer to have the ability to purchase several greeting cards at once with a cohesive concept. It's an experience similar to buying an album from your favorite music artist. Instead of purchasing a ‘single’ (One Greeting Card), you can now buy the collection (8 to 28 cards). Each one will not be the same, and you can send them to others one-by-one until the there are no more perforated pages left to tear out and mail. The consumer, if he or she, chooses, can simply keep the GreetingsBook and cherish the pages, and be comforted by the poetry and pictures.

### SUMMARY OF INVENTION

Every day millions of people purchase greeting cards. I am one of those people. One day, I said to myself, ‘there has to be more than just individual greeting cards out there’. There has to be a product that can be both greeting cards and a book.

Poetry books are too long. Greeting cards are too short. Hallmark makes greeting cards. MeadWestVaco makes spiral bound notebooks. Each company, along with one or two other competitors within their particular industries, controls 80% of the greeting card and spiral bound notebook markets respectively.

I'm a little guy. I saw a void. So I invented the GreetingsBook. Sure there are blank notebooks where the consumer can write his and her thoughts. There are spiral bound notebooks with lines and really thin perforated pages for middle school, high school and college students. And there are greeting cards in the traditional sense.

My product is the combination of the best of all worlds! It provides an outlet other than the traditional single greeting card. It's a stand alone product that won't get lost among hundreds of individual greeting cards.

Here's my 4 line poetic summarization.
“Tear it, read it, share it, Fold it, hold it, make a stack, Stuff it into an envelope Provided in the back!”

What Prevails When All Else Fails?” Poetry Works . . . The GreetingsBook.

And that's what's missing in our lives. The poetry. This product gives people a chance to share the poetry of life. Simplistically.

I did some research and I found Greeting Card Class Code 283/117 and 446/147 contained no patent for a GreetingsBook with my specifications. Neither did Loose Leaf Ring Bound Class Codes D19/27.

### BRIEF DESCRIPTION OF DRAWINGS

A. Front side of page: Perforation, with Text, Scored.
   Shows where perforation is, scoring is done and where spiral binding goes, as well as text.
B. Backside of page: Upside down Art, Perforation, Scored.
   Shows where perforation is, scoring is done and where spiral binding goes, as well as company info, etc. . . .
C. Pouch, Envelops, Spiral binding, con't.

1. A Spiral Book notebook made up pages, which are perforated and scored. These pages convert into greeting cards. Each one can be torn out, placed individually into envelopes provided in the back of the GreetingsBook and mailed. What makes this product unique, is it's a combination of several individual elements. One can purchase scored paper, perforated paper, spiral binding, card stock, etc. . . . One can make his or her, own greeting cards. But there isn't a product on the market that combines all of these elements and sells them together in the form of a GreetingsBook.

2. A product where a collection of greeting cards can exist. For Example: My GreetingsBook entitled “Life, Love & Latte” is a collection of 20 acrostic greeting cards. Each spells downward the name of the retail chain where coffee is sold. This particular collection can only be purchased at that particular chain. Each greeting is about love & relationships. As a consumer needs them, they tear them out, fold them, and place in an envelope, as referenced in claim 1.

3. As referenced in claim 2, The GreetingsBook is a collection of greeting cards bound together in a spiral bound notebook. This collection of cards, as referenced in claim 2 is also a compilation of cards such as; Happy Birthday, I Miss You, I Love You, Thank You, Get Well Soon, Congratulations, Happy Valentine's Day, Happy Holidays, Happy Mother's Day, Happy Father's Day, Happy Halloween, etc. . . . all in one book. The Consumer's are able to purchase the book as a gift for others, or for themselves . . . to send out for each occasion, as they need them.

4. Something very simple that no company is doing. Something that I feel is truly worth pursuing, My small enterprise, so small once you look, Can grow to massive size, with a patented GreetingsBook, Then I can go to companies and market my style of verse. All within a GreetingsBook I can be the first!
